(19) United States
(12) Patent Application Publication
(10) Pub. No.: US 2009/0101156 A1
(43) Pub. Date: Apr. 23, 2009

(54) Support Element for Stabilizing a Patient's Head

(75) Inventor: Hakan Rugfelt, Falsterbo (SE)

Correspondence Address: LERNER GREENBERG STEMER LLP, P O BOX 2480, HOLLYWOOD, FL, 33022-2480, US

(73) Assignee: Kohlbrat & Bunz Gesellschaft m.b.H., Radstadt (AT)

(21) Appl. No.: 12/267,637

(22) Filed: Nov. 10, 2008

Related U.S. Application Data
(63) Continuation of application No. PCT/AT2007/000214, filed on May 7, 2007.

(30) Foreign Application Priority Data
May 9, 2006 (DE) 20 2006 007 422.8

(51) Int. Cl. A61G 15/00

(52) U.S. Cl. 128/845

(57) ABSTRACT

A support element for stabilizing the head of a patient with a cushion containing loose particles that have a clearance between them that can be lessened by vacuuming out the air. Side supporting cushions containing loose particles are disposed on the base cushion.

### CROSS-REFERENCE TO RELATED APPLICATIONS

This is a continuing application, under 35 U.S.C. § 120, of copending international application PCT/AT2007/000214, filed May 7, 2007, which designated the United States; this application also claims the priority, under 35 U.S.C. § 119, of German application DE 20 2006 007 422.8, filed May 9, 2006; the prior applications are herewith incorporated by reference in their entirety.

### BACKGROUND OF THE INVENTION

### Field of the Invention

The present invention relates to a support element for stabilizing the head of a patient with a cushion containing loose particles. The free space clearance of the particles can be reduced by extracting the air.

Commonly assigned U.S. Pat. No. 6,918,393 B2 and its counterpart international publication WO 01/30280 describe a device for supporting the upper body. The device comprises a flexible element filled with loose particles, in particular foamed polystyrene balls. That support element is used in particular with seated injureds and surrounds the upper body, head and neck of the patient, and is adjusted manually to the body form and fixed by fixation belts. By the subsequent evacuation the movement space of the filled-in granulate is reduced and the support element stiffens.

In one embodiment the support element is limited to the head and neck area in which the torso supporting piece is considerably shortened. For the side support of the head the overlapping areas of the support element have to be folded up.

As a head rest for stretchers a multipart immobilization element is in use, which shows a padded baseplate and for each side a foam cube which can be put onto the baseplate which has an opening cut out in the middle to accommodate the ears. The element comprises additional forehead and chin belts as well as fixation and connection elements.

The foam cubes do not adapt to the head shape so that the immobilization element may not be exceedingly convenient. The main disadvantage, however, lies in the multipart implementation, which makes rapid handling more difficult.

### SUMMARY OF THE INVENTION

It is accordingly an object of the invention to provide a support element for stabilizing a patient's head which overcomes the above-mentioned disadvantages of the heretofore-known devices and methods of this general type and which provides for a support element that can be adapted to the head of the patient, is easy and simple to handle, and positions the patient in a way that is as convenient as possible.

With the foregoing and other objects in view there is provided, in accordance with the invention, a support element for stabilizing a head of a patient, comprising:

a base cushion containing loose particles having a clearance that may be reduced by extracting air from the base cushion; and

side supporting cushions disposed on the base cushion, the side supporting cushions containing loose particles.

According to the invention this is achieved by the fact that on the base cushion side supporting cushions are provided that contain loose particles. In this way a headrest is provided whose side supporting cushions to a large extent already adapt to the desired shape when the head is put onto the base cushion, since the filling of the side supporting cushions can shift. It has proven that given this deformation a relatively good stabilization of the head is already achieved without evacuating the side supporting cushions, since easing_of the side supporting cushions fixed on the cushion requires, because of the friction of the particles of the filling, a relatively large expenditure of energy.

Of course the stability of the supporting element is further improved when the side support element after having adapted to the head is completely evacuated. This is necessary especially when injuries of the spinal cord in the neck area are suspected.

In a preferred embodiment it is provided that in order to evacuate all three cushions in a single evacuation process the connecting areas between the side supporting cushions and the base cushion are air-permeable. The air permeability can, for example, be achieved by breaking through the case of the cushions, which then are covered with a tissue or such in order to prevent the transfer of particles between the side supporting cushions and the base cushion.

If the side supporting cushions should be formed relatively high, another preferred embodiment provides that each side supporting cushion is formed out of at least two stacked pads.

Other features which are considered as characteristic for the invention are set forth in the appended claims.

Although the invention is illustrated and described herein as embodied in support element for stabilizing the head, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of a first embodiment of a support element according to the invention;

FIG. 2 is a perspective view of the first embodiment with a schematic representation of a side supporting element adjusted to a non-illustrated head;

FIG. 3 is a perspective view similar to FIG. 1 of a second embodiment of the invention; and

FIG. 4 shows a plan view of a support element according to FIG. 1 or 3.

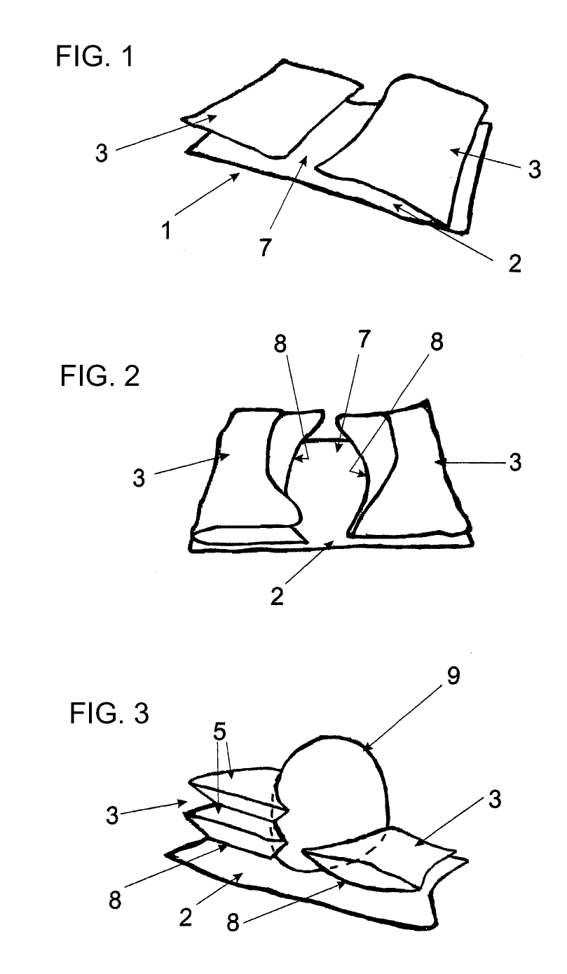

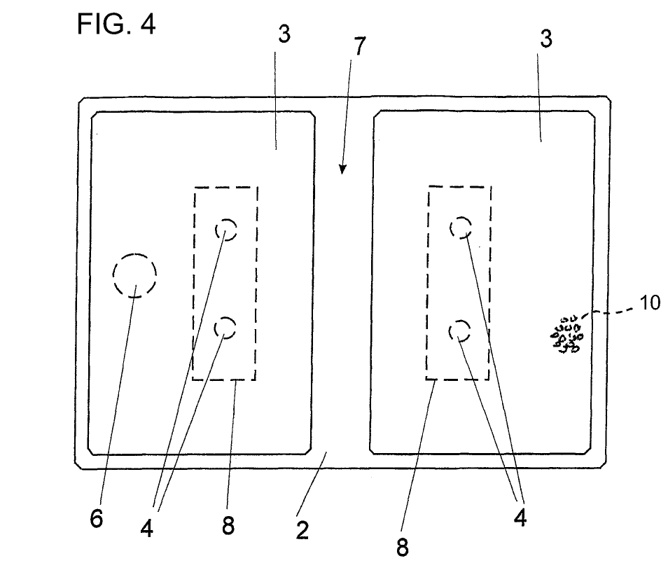

### DETAILED DESCRIPTION OF THE INVENTION

Referring now to the figures of the drawing in detail the device according to the invention is a support element 1 with a base cushion 2 containing loose particles 10, for example granulate of foamed polystyrene, on which on both sides of a support area 7 for the head 9 of a patient side supporting cushions 3 are provided which likewise contain loose particles 10. The cushions 2 and 3 show in particular an outer case made out of a weldable film, so that the side supporting cushions 3 with the base cushion 2 can be connected by a weld 8. Within the area framed by the weld 8 only schematically indicated openings 4 are provided through which the air between the cushions can flow. Thus only one valve 6 is necessary at the base cushion 2 in order to evacuate the support element 1. It would, of course, be possible to provide each cushion 2, 3 with its own valve, but this would delay the handling should all three be evacuated. In particular, at the cushion 2 attachment non-illustrated belts can be disposed which, for example, can be fastened over the forehead or across the chin.

FIG. 3 shows that each side supporting cushion 3 can consist of at least two pads 5, whereby the two pads 5 can preferably be connected to each other in the above described manner and be evacuated together. A second or also third pad 5 on each side can also be smaller, for example only half the size, and only be effective for the upper half of the head.

Preferably the particles are disposed in an air-permeable fabric bag or pouch which is inserted into the airtight cushions 2, 3. This prevents the crossing of particles between the cushions 2, 3. If the particles are filled immediately into the cushions the openings can be covered with an air-permeable piece of fabric.

1. A support element for stabilizing a head of a patient, comprising:
a base cushion containing loose particles having a clearance that may be reduced by extracting air from said base cushion; and
side supporting cushions disposed on said base cushion, said side supporting cushions containing loose particles.

2. The support element according to claim 1, wherein said base cushion and said side supporting cushions are connected by way of a connecting area, and said connecting area between said side supporting cushions and said base cushion is air-permeable.

3. The support element according to claim 1, wherein each of said side supporting cushions is formed with at least two stacked pads.
